(19) United States
(12) Patent Application Publication
(10) Pub. No.: US 2025/0363115 A1
(43) Pub. Date: Nov. 27, 2025

(54) PERFORMANCE MANAGEMENT IN DATA ORCHESTRATED ENVIRONMENTS

(71) Applicant: View Systems, Inc., Dover, DE (US)

(72) Inventors: Joel Christner, El Dorado Hills, CA (US); Keith Barto, Pine, CO (US); Blake Martz, San Diego, CA (US); Alex Nogle, Carlsbad, CA (US); Yipeng Li, Campbell, CA (US)

(73) Assignee: View Systems, Inc., Dover, DE (US)

(21) Appl. No.: 19/214,010

(22) Filed: May 20, 2025

Related U.S. Application Data
(60) Provisional application No. 63/650,378, filed on May 21, 2024.

(51) Int. Cl. G06F 16/2455

(52) U.S. Cl. CPC G06F 16/24568

(57) ABSTRACT

This disclosure provides methods, devices, and systems for data management. The present implementations more specifically relate to a data orchestration system that can dynamically reconfigure a data processing pipeline based on telemetry received from various steps or data operations in the pipeline. For example, the telemetry may indicate a success, failure, time of entry, time of exit, or total duration of a given step or data flow in the processing pipeline. In some aspects, the data orchestration system may dynamically invoke new data flows based on the received telemetry. In some implementations, the new data flows may allocate additional memory and/or processing resources for the data processing pipeline. In some other implementations, the new data flows may deallocate memory and/or processing resources for the data processing pipeline. Still further, in some implementations, the new data flows may trigger an alert to a user or manager of the data processing pipeline.

### CROSS-REFERENCE TO RELATED APPLICATIONS

This application claims priority and benefit under 35 U.S.C. § 119 (e) to U.S. Provisional Patent Application No. 63/650,378, filed May 21, 2024, which is incorporated herein by reference in its entirety.

### TECHNICAL FIELD

This disclosure relates generally to data management in computer systems, and specifically to performance management in data orchestrated environments.

### DESCRIPTION OF RELATED ART

Many businesses store and use data of various types (including structured data and unstructured data), each having its own layout, semantics, and utility for different aspects of a business. Some businesses may benefit by leveraging such data assets as a means of yielding business insights (such as analytics) or creating transformative experiences (such as through machine learning). Machine learning (also referred to as “artificial intelligence”) is a technique for improving the ability of a computer system or application to perform a certain task. Machine learning can be generally broken down into two component parts: training and inferencing. During the training phase, a machine learning system is provided with one or more “answers” and a large volume of raw training data associated with the answers. The machine learning system analyzes the training data to learn a set of rules (also referred to as a machine learning “model”) that can be used to describe each of the answers. During the inference phase, the machine learning system may infer answers from new data using the learned set of rules.

A data management marketplace is a collection of technologies (including applications, functions, and/or modules) produced by open source communities and/or private sector businesses. However, existing data management marketplaces are highly fragmented. For example, many data management marketplaces contain multiple solutions that generally cater to a subset of what an overall data management architecture may require (such as data processing, data preparation, feature extraction, data catalogs, governance, provenance, and/or discovery). As a result, many businesses invest significant time and money into building data processing pipelines that can acquire data assets from various silos, process such data in a meaningful way (such as to extract features), and store the processed data in silos that are accessible to additional processing architectures (such as analytics or machine learning systems and/or applications).

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of data management. The method includes steps of retrieving data from an input data source; processing the data through a data processing pipeline that includes one or more data operations representing a first data flow; acquiring telemetry associated with the first data flow; dynamically reconfiguring the data processing pipeline based at least in part on the telemetry associated with the first data flow; and emitting the processed data to an output data source.

Another innovative aspect of the subject matter of this disclosure can be implemented in a data orchestration system, including a processing system and a memory. The memory stores instructions that, when executed by the processing system, cause the data orchestration system to retrieve data from an input data source; process the data through a data processing pipeline that includes one or more data operations representing a first data flow; acquire telemetry associated with the first data flow; dynamically reconfigure the data processing pipeline based at least in part on the telemetry associated with the first data flow; and emit the processed data to an output data source.

### BRIEF DESCRIPTION OF THE DRAWINGS

The present implementations are illustrated by way of example and are not intended to be limited by the figures of the accompanying drawings.

FIG. 1 shows a block diagram of an example data orchestration system, according to some implementations.

FIG. 2 shows another block diagram of an example data orchestration system, according to some implementations.

FIG. 3 shows a block diagram of an example machine learning system, according to some implementations.

FIGS. 4A and 4B show example user interfaces for dynamically configuring a data processing pipeline, according to some implementations.

FIG. 5 shows another block diagram of an example data orchestration system, according to some implementations.

FIGS. 6A and 6B show example configurations of the data orchestration system shown in FIG. 5.

FIG. 7 shows another block diagram of an example data orchestration system, according to some implementations.

FIG. 8 shows an illustrative flowchart depicting an example data management operation, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems or devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described herein. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, or executed by a computer or other processor.

The various illustrative logical blocks, modules, circuits and instructions described in connection with the implementations disclosed herein may be executed by one or more processors (or a processing system). The term “processor,” as used herein may refer to any general-purpose processor, special-purpose processor, conventional processor, controller, microcontroller, or state machine capable of executing scripts or instructions of one or more software programs stored in memory.

Various aspects relate generally to systems and techniques for data management, and more particularly, to a data orchestration system that can dynamically or programmatically produce a data processing pipeline. As used herein, the terms “data processing pipeline” and “data flow” refer to a series of one or more processing (or preprocessing) operations that can be performed on input data to produce output data that is suitable for a given application or operation (such as analytics or machine learning). The input data is generally retrieved from an input data source or repository and the output data is generally emitted to an output data source or repository, which may be different than the input data source or repository. A data processing pipeline manipulates or transforms the data between the input data source and the output data source. Accordingly, any data processing pipeline generally performs several key steps such as, for example, ingesting data, identifying a content type of the data, extracting key features of the data, performing various operations against the data (such as merging, removal, sanitization, and/or augmentation), and emitting the results to a destination for further use or processing.

In some aspects, the data orchestration system of the present implementations may infer or otherwise determine the steps (or data operations) to be included in a data processing pipeline with little or no input from a user. In some implementations, the data orchestration system may select the steps based, at least in part, on a set of rules and policies defined by a user (or business entity). For example, such rules may indicate where the data is stored, what the data objectives are, how the data should be processed, and where the resultant data should be emitted. With an understanding of where a user's data resides, how the data should be processed, and where the processed data should be emitted, the data orchestration system of the present implementations can suggest or recommend a predefined data processing pipeline based on knowledge of the steps commonly used by others with similar data flows (such as the same or similar input data sources, output data sources, and/or processing requirements). The data orchestration system may further enable the user to modify the recommended data flows in the preconfigured data processing pipeline (or create their own). In some aspects, the data orchestration system may aggregate data regarding usage, flow, and/or steps across multiple (anonymized) users to detect usage patterns, define repositories, and/or recommend data flows (such as by using the data to train a machine learning model).

Existing processes for building data processing pipelines are complex, cumbersome, and prone to errors. Many of the tools used for building such pipelines perform similar tasks in different or inconsistent ways (such as by expecting different forms of inputs or producing different forms of outputs). By preconfiguring data processing pipelines based on commonly used data flows (or prepackaging such data flows to be reused in the construction of data processing pipelines), while allowing the user to modify the data flows and/or create their own, aspects of the present disclosure can provide a more simplified and repeatable process for building data processing pipelines. By inferring data processing pipelines based on a limited and consistent set of user inputs (including an indication of where the data is to be retrieved and an indication of where the data is to be emitted), aspects of the present disclosure can normalize and/or standardize the process by which data processing pipelines are created, enable simple and programmatic creation of data flows, and enable a broader marketplace where data can be shared in such a way that a recommendation engine (such as a machine learning model) can mitigate the burden of creating such data flows by providing best practices and recommendations to users.

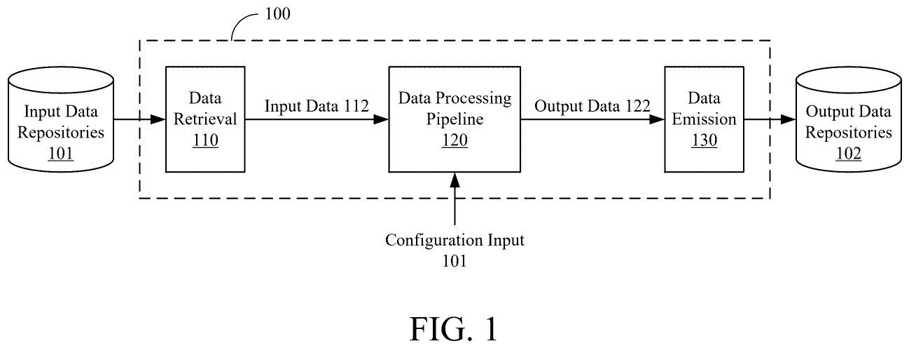

FIG. 1 shows a block diagram of an example data orchestration system 100, according to some implementations. The data orchestration system 100 is configured to retrieve input data 112 from one or more input data repositories 101, process the input data 112 according to one or more data objectives and/or requirements of a processing system or application intended to consume the data, and emit the resulting processed data, as output data 122, to one or more output data repositories 102.

The data orchestration system 100 includes a data retrieval component 110, a data processing pipeline 120, and a data emission component 130. The data retrieval component 110 is configured to communicate or interface with the input data repositories 101 to facilitate the retrieval of the input data 112. Example suitable input data repositories include computers, servers, storage systems, and third-party platforms (such as software-as-a-service (SaaS) platforms), among other examples. In some implementations, the data retrieval component 110 may store information identifying the input data repositories 101 from which the input data 112 can be retrieved. In some implementations, the data retrieval component 110 may detect or identify the input data repositories 101 using network discovery tools (such as by querying Active Directory or performing port scans on the network).

The data processing pipeline 120 is configured to perform one or more data operations that transform the input data 112 into the output data 122. For example, the data operations may include open-source libraries and/or closed-source libraries that are configured to perform discrete tasks against the data. Example suitable tasks include loading data from a file or database, extracting text, stemming or lemmatizing the text, and merging data, among other examples. In some aspects, the data orchestration system 100 may configure or construct the data processing pipeline 120 based on one or more configuration inputs 101. For example, the configuration inputs 101 may specify or define various parameters associated with the data processing pipeline 120 (such as a particular input data repository 101, a particular output data repository 102, a system or application to consume the output data 122, or various other user inputs). In some implementations, the data orchestration system 100 may select one or more data operations to be included in the data processing pipeline 120 based on the configuration inputs 101. In some other implementations, the data orchestration system 100 may determine an order in which to perform the operations based on the configuration inputs 101.

The data emission component 130 is configured to communicate or interface with the output data repositories 102 to facilitate the storage or emission of the output data 122. Example suitable output data repositories include computers, servers, storage systems, and/or third-party platforms that are connected or otherwise accessible to processing systems and/or applications configured for searching, retrieving, using, and/or performing additional processing on the output data 122 (such as for analytics or machine learning). In some implementations, the data emission component 130 also may emit additional data (such as the original input data 112) to be stored in association with the output data 122. For example, the input data 112 and the output data 122 can be stored in a relational database (spanning one or more data repositories) that maps each set of output data 122 to its associated input data 112.

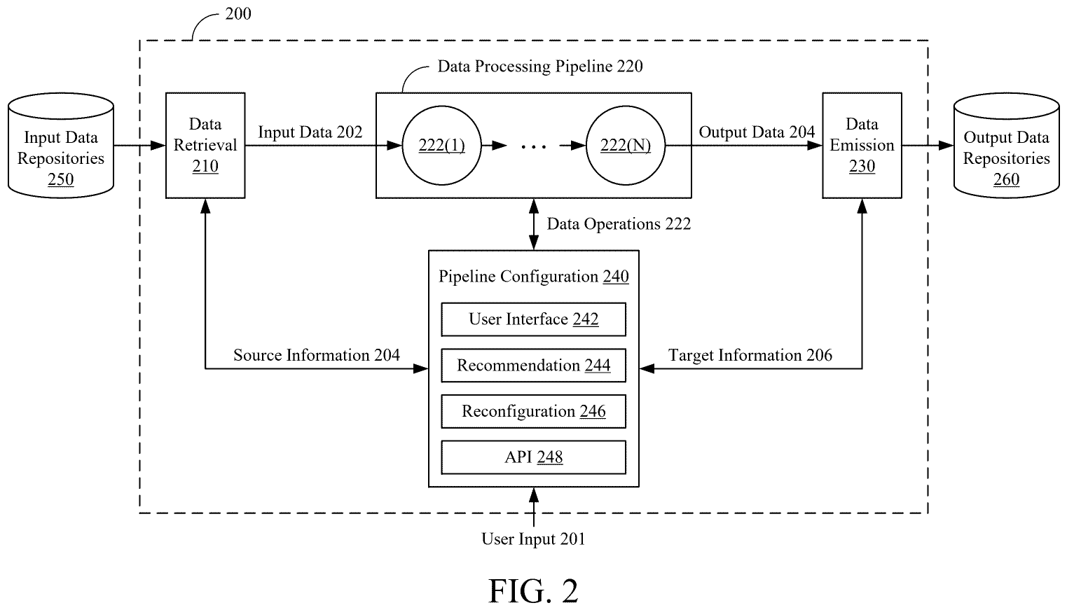

FIG. 2 shows another block diagram of an example data orchestration system 200, according to some implementations. In some implementations, the data orchestration system 200 may be one example of the data orchestration system 100 of FIG. 1. More specifically, the data orchestration system 200 is configured to retrieve input data 202 from one or more input data repositories 250, process the input data 202 according to one or more data objectives and/or requirements of a processing system or application intended to consume the data, and emit the resulting processed data, as output data 204, to one or more output data repositories 260.

The data orchestration system 200 includes a data retrieval component 210, a data processing pipeline 220, a data emission component 230, and a pipeline configuration component 240. The data retrieval component 210 is configured to communicate or interface with the input data repositories 250 to facilitate the retrieval of the input data 202. Example suitable input data repositories 250 include computers, servers, storage systems, and third-party platforms (such as software as a service (SaaS) platforms), among other examples. In some implementations, the data retrieval component 210 may store source information 204 associated with the input data repositories 250. The source information 204 may identify the one or more input data repositories 250 from which the data retrieval component 210 can retrieve the input data 202. In some implementations, the source information 204 also may include connectivity information (such as any information indicating how to connect to the repository) and/or access materials (such as access credentials, authentication information, and application programming interface (API) keys). In some implementations, the data retrieval component 210 may detect or identify the input data repositories 250 using network discovery tools (such as by querying Active Directory or performing port scans on the network).

The data emission component 230 is configured to communicate or interface with the output data repositories 260 to facilitate the storage or emission of the output data 204. Example suitable output data repositories 260 include computers, servers, storage systems, and/or third-party platforms that are connected or otherwise accessible to processing systems and/or applications configured to use or perform additional processing on the output data 204 (such as for analytics or machine learning). In some implementations, the data emission component 230 may store target information 206 associated with the output data repositories 260. The target information 206 may identify the one or more output data repositories 260 to which the data emission component 230 can posit the output data 204.

The data processing pipeline 220 is configured to perform a number (N) of data operations 222(1)-222(N) that transform the input data 202 into the output data 204. As shown in FIG. 2, the data operations 222(1)-222(N) are depicted as vertices (or “steps”) in a directed acyclic graph (DAG) to indicate the flow of data through the data processing pipeline 220. In other words, each step in the DAG has a candidate follow-on step that can be conditionally invoked (based on a success, failure, or exception), where the last step provides the output data 204 to the data emission component 230 or triggers an alert (such as to indicate an error) or invocation of a different data flow. Accordingly, a data flow is defined not only by the set of data operations 222(1)-222(N) but also the order in which the operations are performed and which specific steps are taken given a successful step, a failed step, or a step that encountered an unrecoverable exception. In some implementations, the data processing pipeline 220 may store a set of discrete data operations 222 that can be used to construct a data flow.

The pipeline configuration component 240 is configured to dynamically build the data processing pipeline 220, for example, by mapping one or more of the data operations 222 to a DAG. Aspects of the present disclosure recognize that data flows connecting the same or similar input data repositories 250 (such as data repositories storing the same types of input data) to the same or similar output data repositories 260 (such as data repositories storing the same types of output data) often share a significant amount of commonality. Thus, in some aspects, the pipeline configuration component 240 may configure or select the data operations 222 to be included in the data processing pipeline 220, and/or the order in which they are performed, based at least in part on knowledge of the input data repository 250 from which the input data 202 is retrieved and the output data repository 260 to which the output data 204 is emitted.

In some aspects, the pipeline configuration component 240 may present at least a portion of the source information 204 and the target information 206 on a user interface 242, such as a graphical user interface (GUI) and/or content displayed on an electronic display which allows a user to select, via user inputs 201, an input data repository 250 from which the input data 202 is to be retrieved and an output data repository 260 to which the output data 204 is to be emitted. With reference to FIG. 1, the user inputs 201 may be one example of the configuration inputs 101. The user inputs 201 can include any user interactions associated with the user interface 242. In some implementations, the user inputs 201 may be received via one or more input features (such as touchscreens, buttons, or switches) integrated with the electronic display. In some other implementations, the user inputs 201 may be received via one or more input devices (such as keyboards, mice, or joysticks) coupled to the electronic display.

In some implementations, the pipeline configuration component 240 may further include a recommendation subcomponent 244 and a reconfiguration subcomponent 246. The recommendation subcomponent 244 is configured to generate a preconfigured data flow based, at least in part, on the input data repository 250 and the output data repository 260 selected by the user. For example, the preconfigured data flow may include data operations 222 that are known to be included (or similar to those included) in other data flows connecting the selected input data repository 250 to the selected output data repository 260. In some implementations, the recommendation subcomponent 244 may configure the data processing pipeline 220 to match a predefined data flow commonly used for connecting the selected input data repository 250 to the selected output data repository 260. In some other implementations, the recommendation subcomponent 244 may infer the data operations 222 to be included in the data processing pipeline 220, and the order in which they are performed, based on a machine learning model. For example, the model can be trained based on a variety of data processing pipelines that are used to connect various input data repositories 250 to various output data repositories 260.

In some implementations, the recommendation subcomponent 244 may configure the data processing pipeline 220 based on one or more additional parameters (in addition to the selected input data repository 250 and the selected output data repository 260). For example, the user interface 242 may further allow a user to specify or otherwise indicate, via one or more user inputs 201, what systems or applications will consume the output data 204 and/or how the output data 204 will be used. The recommendation subcomponent 244 may use such information to further refine the preconfigured data flow or tailor the data flow to better suit the needs of the user. For example, knowledge of the systems or applications that will be using the output data 204 (and how the data will be used) enables data flows to be reused across defined policies. In some implementations, the data orchestration system 200 may aggregate such information across multiple users and/or businesses to produce a policy recommendation engine that can further reduce the burden on the user for defining such policies.

The reconfiguration subcomponent 246 is configured to modify or adjust the data processing pipeline 220 based on user input 201. For example, the user interface 242 may display the preconfigured data flow generated by the recommendation subcomponent 244 so that the user can analyze the data flow and make any desired modifications prior to configuring the data processing pipeline 220 to implement the data flow. In some implementations, the user interface 242 may expose the existing data operations 222 that can be included in a data flow and may further enable the user to add data operations 222 to the preconfigured data flow, remove data operations 222 from the preconfigured data flow, and/or change an order in which the data operations 222 are performed in the preconfigured data flow. In some other implementations, the user interface 242 may enable the user to create and add new data operations to the data processing pipeline 220. This allows the user to implement bespoke logic for their data and/or systems, for example, by developing specific functions (packaged as data flow steps). In some aspects, the user interface 242 may provide a low-code interface for creating or specifying data flows, steps, and/or data repositories. For example, the user interface 242 may enable the user to drag-and-drop data operations 222 into the data processing pipeline 220 to create a DAG that connects an input data repository 250 to an output data repository 260.

In some implementations, the pipeline configuration component 240 may further include an API 248 that can be used to integrate the pipeline configuration component 240, or any of the subcomponents 242-246, into other systems and/or workflows (such as for control and events). In some implementations, the API 248 may interface with a data management marketplace to share data operations 222 and/or flows with a community of users. For example, the data operations 222 and/or flows may be delivered through the data management marketplace to allow the community to benefit from the creations of others. In some implementations, the user interface 242 may allow the user of the data orchestration system 200 to specify which, if any, bespoke creations to share with the community.

Accordingly, the data orchestration system 200 can significantly reduce the amount of time that would otherwise be required by a user (such as a software developer) to build a bespoke data processing pipeline 220. The data orchestration system 200 can also provide time-to-value by prepackaging commonly used data flows (including steps for known types of data content and common operations) based on an understanding of usage patterns provided by a marketplace and community of others using a shared platform. Aspects of the present disclosure further recognize that the user inputs 201 received by the data orchestration system 200, and/or other data orchestration systems sharing a platform and/or marketplace with the data orchestration system 200, can be used for training machine learning models to identify common patterns based on previously-defined repositories, content types, data flows, and/or destination systems. Such machine learning models can be used by the recommendation subcomponent 244 to infer preconfigured data flows based on new user inputs 201.

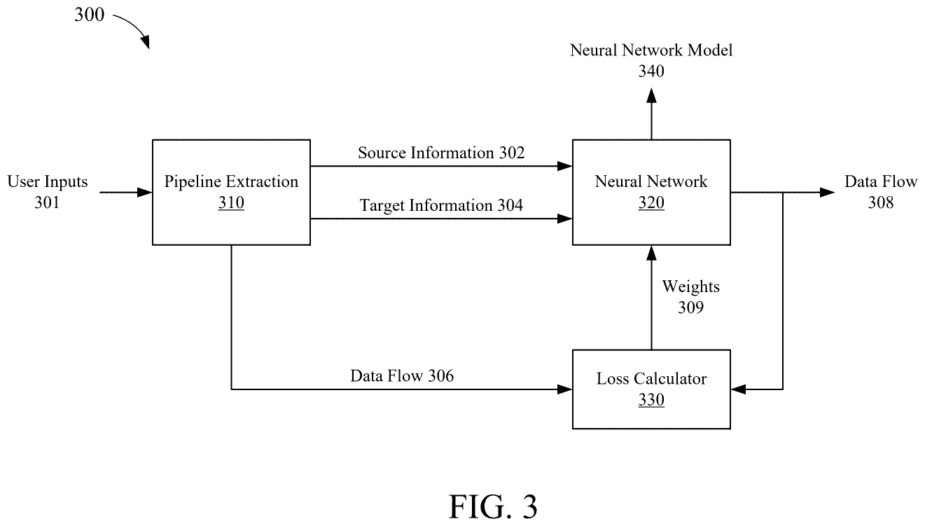

FIG. 3 shows a block diagram of an example machine learning system 300, according to some implementations. The machine learning system 300 is configured to produce a neural network model 340 based, at least in part, on a large volume of user inputs 301 received via one or more data orchestration systems (such as the data orchestration system 200 of FIG. 2). In some implementations, each of the user inputs 301 may be one example of the user input 201 of FIG. 2. In some aspects, the neural network model 340 may be trained to infer a data flow or data processing pipeline that transforms input data (such as the input data 202) into output data (such as the output data 204).

The machine learning system 300 includes a pipeline extraction component 310, a neural network 320, and a loss calculator 330. The pipeline extraction component 310 is configured to parse or extract source information 302, target information 304, and a data flow 306 from the user inputs 301. The source information 302 includes an indication of an input data repository (such as one of the input data repositories 250) from which the input data is to be retrieved and the target information 304 includes an indicating of an output data repository (such as one of the output data repositories 260) to which the output data is to be emitted. In some implementations, the target information 304 may further indicate one or more data objectives associated with the output data (such as what systems or applications will use the output data and/or how the output data will be used). The data flow 306 indicates a series of data operations that transform the input data into the output data (such as the data operations 222(1)-222(N)).

In some implementations, the machine learning system 300 may train the neural network 320 to reproduce the data flow 306 based on the source information 302 and the target information 304. Deep learning is a particular form of machine learning in which the inferencing and training phases are performed over multiple layers. Deep learning architectures are often referred to as “artificial neural networks” due to the manner in which information is processed (similar to a biological nervous system). For example, each layer of an artificial neural network may be composed of one or more “neurons.” Each layer of neurons may perform a different transformation on the output data from a preceding layer so that the final output of the neural network results in the desired inferences. The set of transformations associated with the various layers of the network is referred to as a “neural network model.” Example suitable neural networks include convolutional neural networks (CNNs), recurrent neural networks (RNN), and long short-term memory (LSTM) networks, among other examples.

The neural network 320 receives the source information 302 and the target information 304 and attempts to recreate the data flow 306. For example, the neural network 320 may form a network of connections across multiple layers of artificial neurons that begin with the source information 320 and the target information 304 and lead to an output data flow 308. The connections are weighted to result in an output data flow 308 that closely resembles the data flow 306 (also referred to as the “ground truth data flow”). The training operation may be performed over multiple iterations. In each iteration, the neural network 320 produces an output data flow 308 based on the weighted connections across the layers of artificial neurons, and the loss calculator 330 updates the weights 309 associated with the connections based on an amount of loss (or error) between the output data flow 308 and the ground truth data flow 306. The neural network 320 may output the weighted connections as the neural network model 340 when certain convergence criteria are met (such as when the loss falls below a threshold level or after a predetermined number of training iterations).

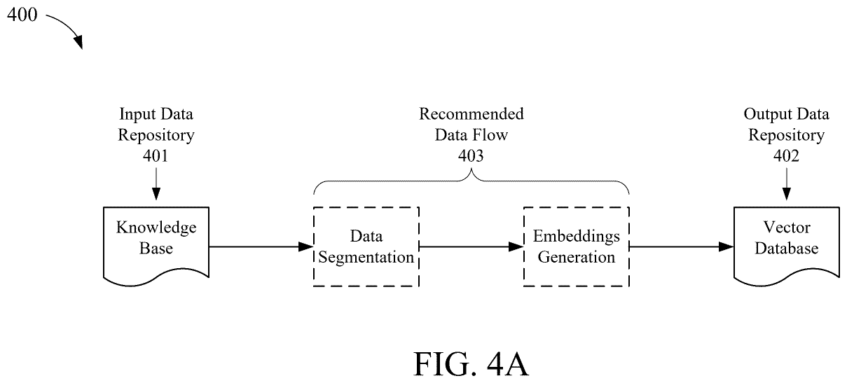

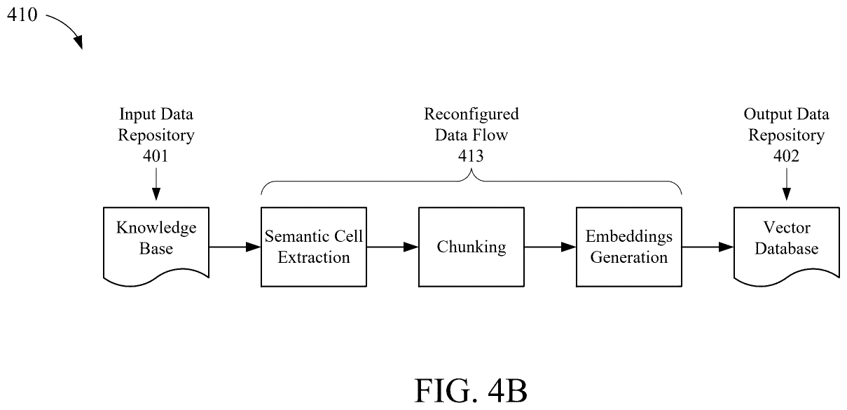

FIG. 4A shows an example user interface 400 for dynamically configuring a data processing pipeline, according to some implementations. In some implementations, the data processing pipeline may be one example of the data processing pipeline 220 of FIG. 2. With reference to FIG. 2, the user interface 400 may be one example of the user interface 242 of the pipeline configuration component 240. In some implementations, the user interface 400 may be a graphical user interface (GUI). More specifically, the user interface 400 allows a user to select an input data repository 401 and an output data repository 402. The user interface 400 further displays a recommended data flow 403 to the user based on the selected input data repository 401 and the selected output data repository 402.

In the example of FIG. 4A, the user selects a knowledge base as the input data repository 401 and selects a vector database as the output data repository 402. A knowledge base is a centralized repository of information that stores, organizes, and provides access to an organization's (or individual's) knowledge and data. More specifically, knowledge bases often serve as a structured databases of information that can be easily searched, retrieved, and/or shared. On the other hand, a vector database is a specialized database system designed to store, manage, and retrieve high-dimensional vector representations of objects and/or data. Unlike traditional databases that organize data in tables with rows and columns, vector databases work with numerical vector embeddings that capture semantic relationships between data points. As such, vector databases are often used in machine learning, AI applications, and semantic search, among other examples.

The pipeline configuration component 240 can determine or infer that the data processing pipeline should be configured to transform or map input data received from the knowledge base to vector embeddings to be stored in the vector database. As shown in FIG. 4A, the user interface 400 can recommend a data flow 403 that includes a data segmentation step (to subdivide the input data into more granular “chunks” or data segments) and an embeddings generation step (to map each of the data segments to a respective vector embedding). In some implementations, the pipeline configuration component 240 may select the recommended data flow 403 from a collection or set of predetermined data flows associated with known input data repositories and known output data repositories. For example, the pipeline configuration component 240 may select a predetermined data flow known to be used for connecting a knowledge base to a vector database. In some other implementations, the pipeline configuration component 240 may infer the recommended data flow 403 based on a machine learning model.

In some implementations, the user interface 400 may further allow the user to modify or reconfigure the recommended data flow 403. For example, a one-to-one mapping of words to embeddings (such as where each embedding represents exactly one word) may improve the precision of search results for specific words at the cost of contextual information. However, because a vector space has a fixed number of dimensions, mapping too many words to a single embedding also may degrade the fidelity of such embeddings. Thus, the user may wish to have finer control over the data segmentation step, for example, to balance the granularity of the data segments with the resource limitations of the data processing pipeline and/or with the data objectives or requirements of the processing system or application intended to consume the resulting vector embeddings.

FIG. 4B shows another example user interface 410 for dynamically configuring a data processing pipeline, according to some implementations. More specifically, the user interface 410 shows a reconfigured data flow 413 which includes modifications to the recommended data flow 403 of FIG. 4A. In the example of FIG. 4B, the user has replaced the data segmentation step of the recommended data flow 403 with a semantic cell extraction step and a chunking step. The pipeline configuration component 240 can respond to such user inputs by removing the data segmentation operation from the data processing pipeline and adding a semantic cell extraction operation, followed by a chunking operation, before the embeddings generation operation.

The semantic cell extraction step is configured to parse the input data into one or more semantic cells. As used herein, the term “semantic cell” refers to a grouping of data that is semantically related. Example suitable semantic cells include sentences, paragraphs, pictures, and/or slides. A semantic cell can also be a “child” of another semantic cell (such as a sentence within a paragraph). The chunking step is configured to arrange the data within each semantic cell into even more granular chunks. As used herein, the term “chunk” refers to a subgrouping of data that is related to a given semantic cell. For example, chunks may be used to break down a semantic cell into smaller groups of data that can be processed more efficiently by a machine or computer (such as a large language model) or yield more accurate and/or precise results. Thus, by replacing the more generic data segmentation step of the recommended data flow 403 with a semantic cell extraction step and a chunking step, the user can fine tune the data processing pipeline to his or her data objectives. In some implementations, the pipeline configuration component 240 may use the reconfigured data flow 413 to train (or retrain) a neural network model (such as described with reference to FIG. 3).

Aspects of the present disclosure further recognize that, while the pipeline configuration component 240 can create a data flow for transforming input data 202 into output data 204, additional resources may be needed to satisfy the real-time requirements of the data flow. Application performance management (APM) is a process used to monitor and manage the performance, success, and/or failure of a distributed system. APM can be used with applications over a network to dissect the amount of time spent on the network, the amount of time spent within each subsystem of a broader distributed system, the end-to-end performance of the network, and the success or failure of the item being monitored. APM also can be configured to produce reporting data, generate alarms, and notify users or administrators of certain thresholds being exceeded (such as when the amount of time taken to complete a checking deposit through a mobile banking application exceeds a threshold amount of time). Intelligent data management (IDM) is a series of steps invoked against source data to process and prepare the data for consumption by other systems (such as analytics or machine learning). In some aspects, a data orchestration environment may implement APM for IDM by invoking additional steps when certain conditions are met or thresholds are exceeded.

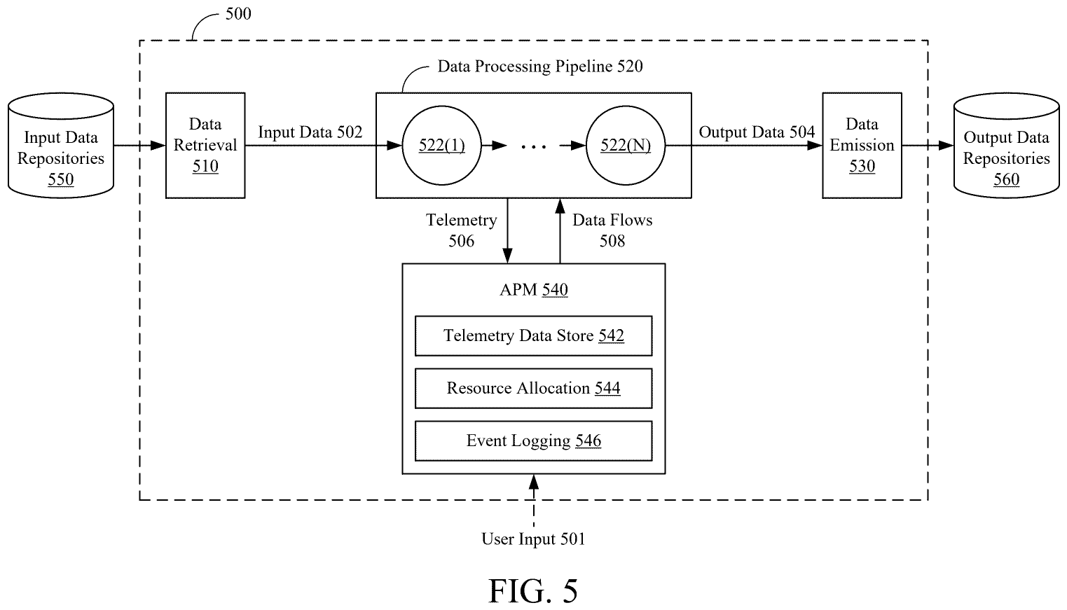

FIG. 5 shows another block diagram of an example data orchestration system 500, according to some implementations. The data orchestration system 500 is configured to retrieve input data 502 from one or more input data repositories 550, process the input data 502 according to one or more data objectives and/or requirements of a processing system or application intended to consume the data, and emit the resulting processed data, as output data 504, to one or more output data repositories 560.

The data orchestration system 500 includes a data retrieval component 510, a data processing pipeline 520, a data emission component 530, and an APM 540. In some implementations, the data retrieval component 510, the data processing pipeline 520, and the data emission component 530 may be examples of the data retrieval component 210, the data processing pipeline 220, and the data emission component 230, respectively, of FIG. 2. The data retrieval component 510 is configured to communicate or interface with the input data repositories 550 to facilitate the retrieval of the input data 502. The data processing pipeline 520 is configured to perform a number (N) of data operations 522(1)-522(N) that transform the input data 502 into the output data 504. The data emission component 530 is configured to communicate or interface with the output data repositories 560 to facilitate the storage or emission of the output data 504.

The APM 540 is configured to monitor telemetry 506 from the data processing pipeline 520 and its subordinate steps 522, and invoke additional steps and/or actions when certain conditions or thresholds are met. The telemetry 506 may include telemetry received from each step in the data flow and may indicate various real-time characteristics associated with that step (such as time of entry, time of exit, total runtime, success or failure, and more fine-grained time-related or other details from the constituent logic within the step). The telemetry 506 also may include telemetry received from the data flow itself (such as the time of entry, time of exit, total runtime, and success or failure of the data flow as a whole). The APM 540 may store the telemetry 506, including any associated metadata, in a telemetry data store 542 configured to correlate discrete pieces of telemetry with specific invocations of the data flow and its constituent steps. In some implementations, the telemetry data store 542 may aggregate the telemetry 506 to produce overall, filtered, and fine-grained reporting.

The APM 540 further includes a resource allocation component 544 and an event logging component 546. The resource allocation component 544 is configured to dynamically allocate and deallocate system resources (such as processing and/or memory resources) based on performance metrics indicated by the telemetry 506. In some implementations, the resource allocation component 544 may invoke one or more additional data flows 508 that can provide additional processing power for a given task or data operation when the telemetry 506 indicates that the time spent performing the operation exceeds an upper threshold amount of time. In some other implementations, the resource allocation component 544 may invoke one or more additional data flows 508 that can reduce the processing power for a given task or data operation (such as to revert the operating environment back to normal capacity) when the telemetry 506 indicates that the time spent performing the operation is below a lower threshold amount of time.

The event logging component 546 is configured to trigger one or more alerts, alarms, and/or notifications based on events associated with the telemetry 506. For example, the event logging component 546 may generate an alert when the telemetry 506 indicates that the data flow and/or a particular data operation therein failed. In some implementations, the event logging component 546 may invoke one or more data flows 508 to trigger the alert. Example suitable data flows 508 may include sending a message or email to parties that may be interested in the associated event, creating a ticket with an information technology (IT) system, or recording the event in a bug tracking system, among other examples. In some implementations, the APM 540 (including the resource allocation component 544 and the event logging component 546) may respond to user-defined polices. For example, a user may specify, via one or more user inputs 501, the conditions, events, and/or thresholds that trigger responses or actions by the APM 546.

By integrating the APM 540 into the data orchestration system 500, aspects of the present disclosure can monitor and manage the data flows and steps implemented by the data processing pipeline 520. More specifically, the APM 540 provides the data orchestration system 500 with the ability to manage, monitor, and act on telemetry 560 indicating the real-time performance of discrete steps in the data flow, the overall performance of the entire data flow, and success or failure conditions encountered within an invocation of a data flow or across a history of data flows. This allows the data orchestration system 500 to automate remediation tasks natively, within the same orchestration layer used for performing data processing tasks. The APM 540 also may provide fine-grained monitoring, visibility, and reaction related to the performance, success, and failure of any constituent steps within a data flow, for the data flow itself, and/or across multiple data flows. For example, a user may define a data flow with a series of steps that spawns additional processing resources in the event that congestion or poor performance is encountered within the orchestration system.

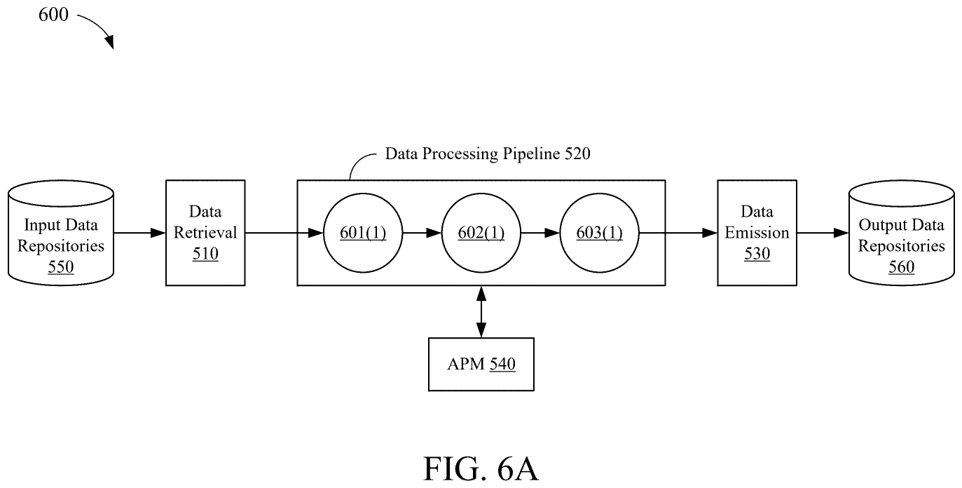

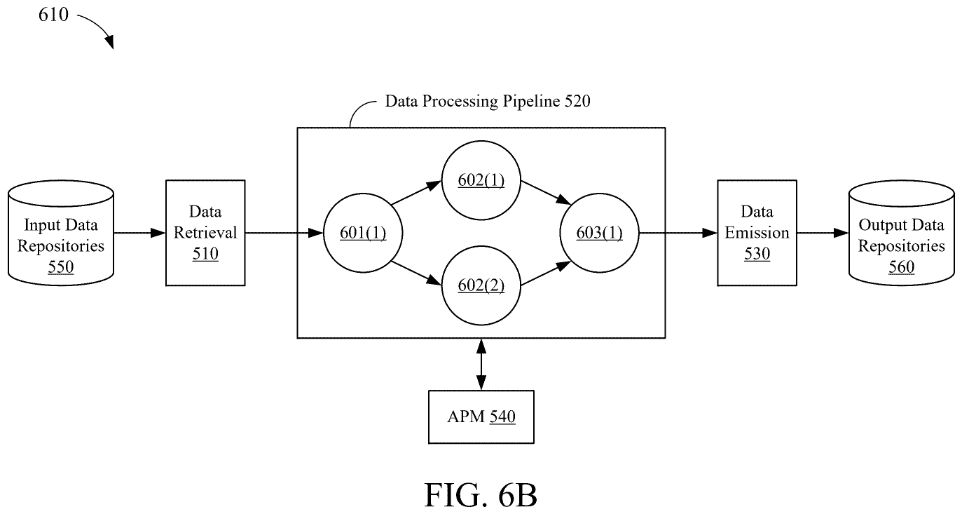

FIG. 6A shows an example configuration 600 the data orchestration system 500 shown in FIG. 5. As described with reference to FIG. 5, the data retrieval component 510 retrieves input data 502 from one or more of the input data repositories 550, the data processing component 520 processes or transforms the input data 502 into output data 504, and the data emission component 530 emits the output data 504 to one or more output data repositories 560. In the example of FIG. 6A, the data processing pipeline 520 is shown to include a single data flow formed by 3 subordinate steps 601(1), 602(1), and 603(1). More specifically, the first step 601(1) performs a first data operation on the input data 502, the second step 602(1) performs a second data operation on the output of the first step 601(1), and the third step 603(1) performs a third data operation on the output of the second step 603(1), which results in the output data 504.

The APM 540 can receive or otherwise acquire telemetry from each step 601(1), 602(1), and 603(1) of the data flow. As described with reference to FIG. 5, the telemetry can indicate a success or failure of a given step, a time of entry or exit for a given step, and/or a total runtime or duration of a given step, among other examples. In some implementations, the APM 540 may determine that the second step 602(1) is running too slow. For example, the APM 540 can receive telemetry indicating that the duration of the second step 602(1) has exceeded a threshold duration associated with that step. To reduce the bottleneck at the second step 602(1), the APM 540 can invoke a second data flow that allocates additional resources for the data processing pipeline 520.

FIG. 6B shows another example configuration 610 the data orchestration system 500 shown in FIG. 5. More specifically, in the example configuration 610 of FIG. 6B, the APM 540 has invoked a second data flow, which adds a subordinate step 602(2), in the data processing pipeline 520. For example, the second step 602(2) of the second data flow may perform the same or similar data operation as the second step 602(1) of the first data flow. Thus, while the data processing pipeline 520 waits for the second step 602(1) to complete its data operation, the first step 601(1) can redirect its output to the second step 602(2). In this way, the second step 602(1) and the second step 602(2) can process the outputs of the first step 601(1) concurrently or in parallel, thereby reducing the bottleneck at the second step of the data processing pipeline 520.

In some implementations, the APM 540 may subsequently determine that the second step 602(1) and/or the second step 602(2) is being underutilized. For example, the APM 540 can receive telemetry indicating that the duration of the second step 602(1) and/or the duration of the second step 602(2) is below a threshold duration associated with that step. To reduce excess resource consumption and/or waste, the APM 540 can invoke a third data flow that deallocates the additional resources for the data processing pipeline 520. For example, the third data flow can reduce or eliminate the parallel data operations at the second step of the data processing pipeline 520. As a result, the third data flow may appear substantially similar to the first data flow of FIG. 6A.

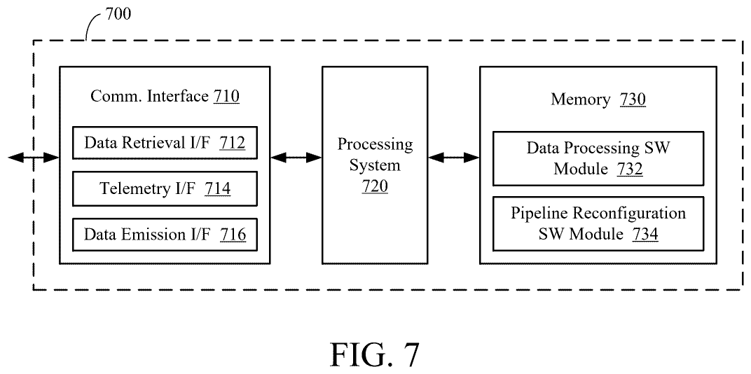

FIG. 7 shows another block diagram of an example data orchestration system 700, according to some implementations. In some implementations, the data orchestration system 700 may be one example of the data orchestration systems 500 of FIG. 5. More specifically, the data orchestration system 700 is configured to retrieve input data from one or more input data repositories, process the input data according to one or more data objectives and/or requirements of a processing system or application intended to consume the data, and emit the resulting processed data, to one or more output data repositories.

The data orchestration system 700 includes a communication interface 710, a processing system 720, and a memory 730. The communication interface 710 is configured to communicate with one or more data repositories and/or user interfaces. More specifically, the communication interface 710 includes a data retrieval interface (I/F) 712 for communicating with one or more components of a data processing pipeline (such as the input data repositories 550 of FIG. 5), telemetry interface (I/F) 714 for communicating with one or more sources of user input (such as the data processing pipeline 520 of FIG. 5), and a data emission interface (I/F) 716 for communicating with one or more output data repositories (such as the output data repositories 560 of FIG. 5).

In some implementations, the data retrieval interface 712 may retrieve data from an input data source. In some implementations, the telemetry interface 714 may acquire telemetry associated with a first data flow. In some implementations, the data emission interface 716 may emit processed data to an output data source.

The memory 730 includes a non-transitory computer-readable medium (including one or more nonvolatile memory elements, such as EPROM, EEPROM, Flash memory, or a hard drive, among other examples) that can store the following software (SW) modules: a data processing SW module 732 to process the data through a data processing pipeline that includes one or more data operations representing the first data flow; and a pipeline reconfiguration SW module 734 to dynamically reconfigure the data processing pipeline based at least in part on the telemetry associated with the first data flow.

The processing system 720 includes any suitable one or more processors capable of executing scripts or instructions of one or more software programs stored in the data retrieval platform 700 (such as in the memory 730). For example, the processing system 720 can execute the data processing SW module 732 to process the data through a data processing pipeline that includes one or more data operations representing the first data flow. The processing system 720 can also execute the pipeline reconfiguration SW module 734 to dynamically reconfigure the data processing pipeline based at least in part on the telemetry associated with the first data flow.

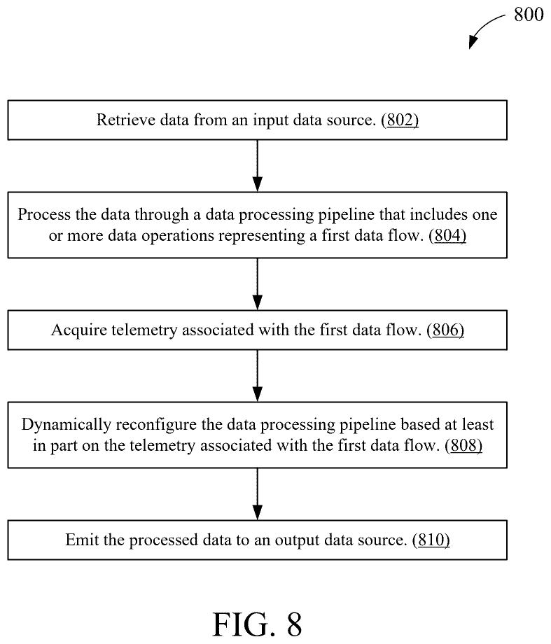

FIG. 8 shows an illustrative flowchart depicting an example data management operation 800, according to some implementations. In some implementations, the example operation 800 may be performed by a data orchestration system such as the data orchestration system 700 of FIG. 7.

The data orchestration system retrieves data from an input data source (802). The data orchestration system processes the data through a data processing pipeline that includes one or more data operations representing a first data flow (804). The data orchestration system also acquires telemetry associated with the first data flow (806). The data orchestration system dynamically reconfigures the data processing pipeline based at least in part on the telemetry associated with the first data flow (808). In some implementations, the data orchestration system may receive user input indicating one or more conditions for reconfiguring the data processing pipeline, where the data processing pipeline is reconfigured based on the telemetry indicating that the one or more conditions are satisfied. The data orchestration system further emits the processed data to an output data source (810).

In some aspects, the telemetry may indicate a success or failure of at least one data operation of the one or more data operations. In some implementations, the data orchestration system may further generate a notification responsive to receiving the telemetry indicating a failure of the at least one data operation. In some other aspects, the telemetry may indicate a time of entry or exit for at least one data operation of the one or more data operations. Still further, in some aspects, the telemetry may indicate a duration of at least one data operation of the one or more data operations.

In some aspects, the dynamic reconfiguring of the data processing pipeline may include determining that the duration of the at least one data operation exceeds a threshold duration and invoking a second data flow in the data processing pipeline responsive to determining that the duration of the at least one data operation exceeds the threshold duration. In some implementations, the second data flow may allocate additional resources for the data processing pipeline.

In some other aspects, the dynamic reconfiguring of the data processing pipeline may include determining that the duration of the at least one data operation is below a threshold duration and invoking a second data flow in the data processing pipeline responsive to determining that the duration of the at least one data operation is below the threshold duration. In some implementations, the second data flow may deallocate resources for the data processing pipeline.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of data management, comprising:
retrieving data from an input data source;
processing the data through a data processing pipeline that includes one or more data operations representing a first data flow;
acquiring telemetry associated with the first data flow;
dynamically reconfiguring the data processing pipeline based at least in part on the telemetry associated with the first data flow; and
emitting the processed data to an output data source.

2. The method of claim 1, wherein the telemetry indicates a success or failure of at least one data operation of the one or more data operations.

3. The method of claim 2, further comprising:
generating a notification responsive to receiving the telemetry indicating a failure of the at least one data operation.

4. The method of claim 1, wherein the telemetry indicates a time of entry or exit for at least one data operation of the one or more data operations.

5. The method of claim 1, wherein the telemetry indicates a duration of at least one data operation of the one or more data operations.

6. The method of claim 5, wherein the dynamic reconfiguring of the data processing pipeline comprises:
determining that the duration of the at least one data operation exceeds a threshold duration; and
invoking a second data flow in the data processing pipeline responsive to determining that the duration of the at least one data operation exceeds the threshold duration.

7. The method of claim 6, wherein the second data flow allocates additional resources for the data processing pipeline.

8. The method of claim 5, wherein the dynamic reconfiguring of the data processing pipeline comprises:
determining that the duration of the at least one data operation is below a threshold duration; and
invoking a second data flow in the data processing pipeline responsive to determining that the duration of the at least one data operation is below the threshold duration.

9. The method of claim 8, wherein the second data flow deallocates resources for the data processing pipeline.

10. The method of claim 1, further comprising:
receiving user input indicating one or more conditions for reconfiguring the data processing pipeline, the data processing pipeline further being reconfigured based on the telemetry indicating that the one or more conditions are satisfied.

11. A data orchestration system comprising:
a processing system; and
a memory storing instructions that, when executed by the processing system, causes the data orchestration system to:
retrieve data from an input data source;
process the data through a data processing pipeline that includes one or more data operations representing a first data flow;
acquire telemetry associated with the first data flow;
dynamically reconfigure the data processing pipeline based at least in part on the telemetry associated with the first data flow; and
emit the processed data to an output data source.

12. The data orchestration system of claim 11, wherein the telemetry indicates a success or failure of at least one data operation of the one or more data operations.

13. The data orchestration system of claim 12, wherein execution of the instructions further causes the data orchestration system to:
generate a notification responsive to receiving the telemetry indicating a failure of the at least one data operation.

14. The data orchestration system of claim 11, wherein the telemetry indicates a time of entry or exit for at least one data operation of the one or more data operations.

15. The data orchestration system of claim 11, wherein the telemetry indicates a duration of at least one data operation of the one or more data operations.

16. The data orchestration system of claim 15, wherein the dynamic reconfiguring of the data processing pipeline comprises:
determining that the duration of the at least one data operation exceeds a threshold duration; and
invoking a second data flow in the data processing pipeline responsive to determining that the duration of the at least one data operation exceeds the threshold duration.

17. The data orchestration system of claim 16, wherein the second data flow allocates additional resources for the data processing pipeline.

18. The data orchestration system of claim 15, wherein the dynamic reconfiguring of the data flow comprises:
determining that the duration of the at least one data operation is below a threshold duration; and
invoking a second data flow in the data processing pipeline responsive to determining that the duration of the at least one data operation is below the threshold duration.

19. The data orchestration system of claim 18, wherein the second data flow deallocates resources for the data processing pipeline.

20. The data orchestration system of claim 11, wherein execution of the instructions further causes the data orchestration system to:
receive user input indicating one or more conditions for reconfiguring the data flow, the data flow further being reconfigured based on the telemetry indicating that the one or more conditions are satisfied.
